(19) United States
(12) Patent Application Publication
(10) Pub. No.: US 2024/0075743 A1
(43) Pub. Date: Mar. 7, 2024

(54) Maintenance Liquid, Maintenance Method, Recording Apparatus, And Ink Set

(71) Applicant: SEIKO EPSON CORPORATION, Tokyo (JP)

(72) Inventors: Miki UCHIDA, Matsumoto (JP); Yusuke MIZUTAKI, Shiojiri (JP); Yuko HISHIDA, Matsumoto (JP); Hiromichi TAKANASHI, Shiojiri (JP); Tomohiro KAWASAKI, Shiojiri (JP)

(21) Appl. No.: 18/458,578

(22) Filed: Aug. 30, 2023

(30) Foreign Application Priority Data
Aug. 31, 2022 (JP) 2022-137618

(51) Int. Cl. B41J 2/165; C09D 11/322

(52) U.S. Cl. CPC B41J 2/16552; C09D 11/322; B41J 2002/16558

(57) ABSTRACT

A water-based maintenance liquid is used for a recording apparatus, the recording apparatus is an apparatus to perform recording by ejecting at least two types of water-based ink compositions from an ink jet head, the ink jet head has a nozzle surface in which nozzles to eject the water-based ink compositions are formed, the nozzles are formed in the nozzle surface respectively for the at least two types of water-based ink compositions, the maintenance liquid is used to moisturize the nozzle surface by being supplied to a cap portion which covers the nozzle surface and includes water and a moisturizing agent component which contains at least one type of moisturizing agent, the moisturizing agent component is a water-soluble organic compound, and a content A (percent by mass) of the moisturizing agent component with respect to a total mass of the moisturizing agent component and the water satisfies a predetermined equation.

The present application is based on, and claims priority from JP Application Serial Number 2022-137618, filed Aug. 31, 2022, the disclosure of which is hereby incorporated by reference herein in its entirety.

### BACKGROUND

### 1. Technical Field

The present disclosure relates to a maintenance liquid, a maintenance method, a recording apparatus, and an ink set.

### 2. Related Art

Since being able to record a highly fine image by a relatively simple apparatus, an ink jet recording method has been rapidly developed in various fields. In the ink jet recording, an ink is ejected from a nozzle of an ink jet head. When the ink is dried in the nozzle, clogging is liable to occur.

Accordingly, during a time period in which no recording is performed, in order to prevent the nozzle of the ink jet head from being dried, a maintenance liquid to moisturize the nozzle is used.

In the case described above, since the maintenance liquid is filled in a head cap which covers a nozzle surface of the ink jet head, and air in a tightly closed space between the cap and the nozzle surface is moisturized, the nozzle is expected to be moisturized through the air in the tightly closed space.

JP-A-2010-89404 has disclosed a maintenance liquid which is used for an ink jet type recording apparatus and which contains at least water, a water-soluble colorant, a pH adjuster, and one type of water-soluble organic solvent selected from an alkanediol and an alkylene glycol monoether derivative.

In the case in which an ink jet head to eject at least two types of inks is moisturized, a maintenance liquid capable of moisturizing the ink jet head so as to suppress the changes in composition of the at least two types of inks has not been satisfactorily realized.

### SUMMARY

According to an aspect of the present disclosure, there is provided a water-based maintenance liquid used for a recording apparatus, the recording apparatus is an apparatus to perform recording by ejecting at least two types of water-based ink compositions from an ink jet head, the ink jet head has a nozzle surface in which nozzles to eject the water-based ink compositions are formed, the nozzles are formed in the nozzle surface respectively for the at least two types of water-based ink compositions, and the maintenance liquid is used to moisturize the nozzle surface by being supplied to a cap portion which covers the nozzle surface. In addition, the maintenance liquid includes water and a moisturizing agent component containing at least one type of moisturizing agent, the moisturizing agent component is a water-soluble organic compound, and a content A (percent by mass) of the moisturizing agent component with respect to a total mass of the moisturizing agent component and the water satisfies Equation (1) which will be described later.

According to another aspect of the present disclosure, there is provided a maintenance method comprising: a step of supplying the maintenance liquid described above to the cap portion which covers the nozzle surface of the ink jet head of the recording apparatus described above so as to moisturize the nozzle surface.

According to another aspect of the present disclosure, there is provided a recording apparatus comprising: the maintenance liquid described above and an ink jet head having the nozzle surface to be moisturized by the maintenance liquid.

According to another aspect of the present disclosure, there is provided an ink set comprising the maintenance liquid described above and the at least two types of water-based ink compositions described above.

### BRIEF DESCRIPTION OF THE DRAWINGS

FIG. 1 is a schematic view of a peripheral structure of a maintenance liquid in a recording apparatus.

FIG. 2 is a conceptual view of the state in which a container α and a container β are left still in one tightly closed container.

FIG. 3 is a conceptual view showing a calculation method of a moisture absorption rate (g/h).

FIG. 4 is a conceptual view showing a calculation method of X₁ to Xₘ.

FIG. 5 is a conceptual view showing a calculation method of Xₘₐₓ and Xₘᵢₙ.

### DESCRIPTION OF EMBODIMENTS

Hereinafter, if needed, with reference to the drawings, although each embodiment (hereinafter, referred to as “this embodiment”) of the present disclosure will be described in detail, the present disclosure is not limited thereto and may be variously changed and/or modified without departing from the scope of the present disclosure. In addition, in the drawing, the same element is designated by the same reference mark, and duplicated description will be omitted. In addition, unless otherwise particularly described, the positional relationship, such as right to left and up to down, is based on the positional relationship shown in the drawing. Furthermore, the dimensional ratio in the drawing is not limited to that shown in the drawing.

### 1. Maintenance Liquid

A maintenance liquid according to this embodiment is a water-based maintenance liquid used for a recording apparatus, the recording apparatus is an apparatus to perform recording by ejecting at least two types of water-based ink compositions (hereinafter, also simply referred to as “ink compositions” in some cases) from an ink jet head, the ink jet head has a nozzle surface in which nozzles to eject the above water-based ink compositions are formed, in the nozzle surface, the nozzles are formed respectively for the at least two types of water-based ink compositions, and the maintenance liquid is used to moisturize the nozzle surface by being supplied to a cap portion which covers the nozzle surface. In addition, the maintenance liquid includes water and a moisturizing agent component containing at least one type of moisturizing agent, the moisturizing agent component is a water-soluble organic compound, and a content A (percent by mass) of the moisturizing agent component with respect to a total mass of the moisturizing agent component and the water satisfies the following Equation (1).

Xₘᵢₙ−5≤A≤Xₘₐₓ+5 Equation (1)

In addition, when the following procedures 1 to 3 are performed, Xₘᵢₙ and Xₘₐₓ are each a value defined by the following definition 1.

### Procedure 1

At least three types of liquid compositions (hereinafter, also referred to as P₁, P₂, P₃, . . . Pₙ, and n represents an integer of 3 or more) each formed from a moisturizing agent component and water, contents B (percent by mass) of the moisturizing agent components each with respect to a total mass of the moisturizing agent component and the water being different from each other, and the at least two types of water-based ink compositions (hereinafter, also referred to as Q₁, Q₂, . . . Qₘ, and m represents an integer of 2 or more) are prepared. The moisturizing agent component of the liquid composition has the same composition as that of the moisturizing agent component included in the maintenance liquid.

Subsequently, a container α in which the liquid composition P₁ is received and a container β in which the ink Q₁ is received, the mass thereof being the same as that of the liquid composition P₁, are left still in a tightly closed container in an environment at a temperature of 25° C. and a relative humidity of 50%. In addition, based on the change in mass of the liquid composition P₁ with time, a moisture absorption rate (g/h) of the liquid composition P₁ to the ink Q₁ is calculated.

In a manner similar to that described above, a moisture absorption rate (g/h) of the ink Q₁ to the liquid composition P₁ is also calculated.

Next, except for that the liquid composition P₁ is changed, the above operation is performed on each of the liquid compositions P₂, P₃, . . . Pₙ Linder conditions similar to the above conditions. Accordingly, the moisture absorption rates of the liquid compositions and n types of moisture absorption rates of the ink Q₁ corresponding thereto are calculated.

### Procedure 2

In a graph in which the vertical axis indicates the moisture absorption rate, and the horizontal axis indicates the content B of the moisturizing agent component of the liquid composition, after the moisture absorption rates (g/h) of the liquid compositions and the n types of moisture absorption rates (g/h) of the ink Q₁ corresponding thereto are plotted with the content B, an approximate straight line of the moisture absorption rates (g/h) of the liquid compositions and an approximate straight line of the n types of moisture absorption rates (g/h) of the ink Q₁ are formed, respectively.

In addition, a content B located at a point at which the approximate straight line of the moisture absorption rates (g/h) of the liquid compositions and the approximate straight line of the n types of moisture absorption rates (g/h) of the ink Q₁ are intersected to each other is represented by X₁.

### Procedure 3

Except for that the ink Q₁ is changed, the procedures 1 and 2 are performed on each of the inks Q₂ . . . Qₘ under conditions similar to the above conditions. As a result, X₁, X₂, . . . Xₘ are obtained.

### Definition 1

Among X₁, X₂, . . . Xₘ thus obtained, the maximum value is represented by Xₘₐₓ, and the minimum value is represented by Xₘᵢₙ.

As described above, the maintenance liquid of this embodiment is a water-based maintenance liquid used for maintenance of an ink jet head of a recording apparatus to perform recording by ejecting the at least two types of water-based ink compositions from the ink jet head.

When at least two types of inks are ejected from the ink jet head, a head cap is provided so as to collectively cover the nozzles to ejects the at least two types of inks, and hence, the nozzles for the at least two types of inks are simultaneously moisturized. Accordingly, compared to the case in which caps are provided for respective types of inks, the recording apparatus can be simplified, and the space therefor can also be reduced.

It was found that when the concentration of the moisturizing agent contained in the maintenance liquid is excessively high or low with respect to the ink to be used, an increase or a decrease in moisture in the ink in the vicinity of the nozzle is generated during the maintenance. In particular, when the concentration of the moisturizing agent contained in the maintenance liquid is excessively high, water contained in the ink in the nozzle is unfavorably absorbed in the maintenance liquid, the ink in the vicinity of the nozzle is not moisturized at all, and the drying of the ink is promoted; hence, a clogging recovery property is liable to be degraded. On the other hand, when the concentration of the moisturizing agent contained in the maintenance liquid is excessively low, the ink in the vicinity of the nozzle absorbs water from the maintenance liquid, the content of water in the ink is increased, and for example, the viscosity of the ink is decreased; hence, flight bending is liable to occur after the ejection. Accordingly, a maintenance liquid which is able to suppress the change in composition of the ink used for the ink jet recording has been required.

When the ink jet head ejects at least two types of inks, a maintenance liquid which is able to suppress the change in composition of each of the at least two types of inks is required.

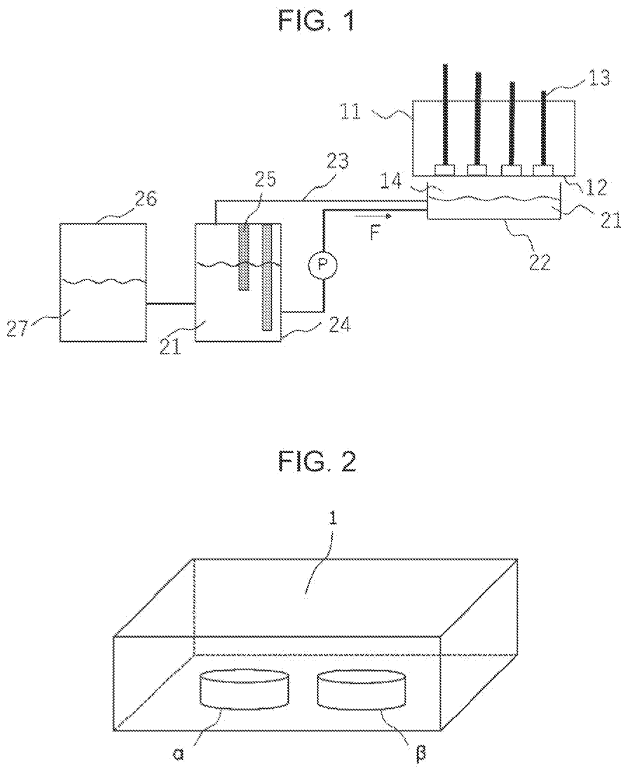

FIG. 1 is a schematic view showing one example of a peripheral structure of a maintenance liquid in a recording apparatus. As shown in FIG. 1, the recording apparatus ejects inks from an ink jet head 11 through ink flow paths 13. The ink jet head 11 has a nozzle surface 12 in which nozzles to eject inks are formed. In the example shown in FIG. 1, the ink jet head 11 has nozzles to eject four types of (four) inks and has the ink flow paths 13 for the respective types of inks. In addition, nozzles to eject one of the four types of inks may also be provided, and the nozzles described above may form a nozzle line. The number of types of inks is preferably at least two, more preferably 4 to 10, and further preferably 4 to 7.

To the ink flow path 13, for example, the ink is supplied from an ink container (not show) located upstream.

In a tank 24, a maintenance liquid 21 is stored. When the recording apparatus is installed and is then to be used, the maintenance liquid 21 is charged in the tank 24 from a maintenance liquid container (not shown) or the like, is stored therein as a new maintenance liquid, and is then used for the maintenance in the recording apparatus. The maintenance liquid container is a container to receive an unused and new maintenance liquid and to supply it to the tank 24 of the recording apparatus, and for example, a maintenance liquid pack may also be used.

The nozzle surface 12 of the ink jet head 11 may be covered with a cap portion 22 during the maintenance. Since being supplied to the cap portion 22 which covers the nozzle surface 12 of the ink jet head 11, the maintenance liquid 21 is used to moisturize the nozzle surface 12. To this cap portion 22, the maintenance liquid 21 is supplied from the tank 24 through a flow path 23 along a direction F.

In addition, the nozzle surface 12 and the cap portion 22 may form a closed space 14, and this closed space 14 may be moisturized while the maintenance liquid 21 is not in contact with the nozzle surface 12. In this case, the closed space 14 may be either a tightly closed space or a non-tightly closed space. A tightly closed space is preferable. Accordingly, without any contact between the maintenance liquid 21 and the ink, the closed space 14 can be moisturized.

Because of air moisturized in the closed space 14, the nozzles in the nozzle surface of the ink jet head 11 are moisturized, the ink in the nozzle is prevented from being dried, and hence, the ink in the nozzle is prevented from being increased in viscosity and being solidified. Accordingly, the maintenance to moisturize the ink jet head 11 can be performed.

In addition, an anti-permeable film may also be provided at an upper portion of the maintenance liquid in the cap portion 22 so that the maintenance liquid is not brought into contact with the nozzle surface (evaporation components are allowed to permeate through the film).

After the maintenance is performed, the maintenance liquid 21 supplied to the cap portion 22 may be returned through the flow path 23 to the tank 24 in which the maintenance liquid is stored. Accordingly, the maintenance liquid 21 can be repeatedly used for the maintenance. In addition, when the maintenance is not performed, the maintenance liquid may be treated so as not to be present at a place other than the tank 24.

The maintenance liquid 21 is gradually decreased since the maintenance liquid 21 may be spilled from the cap portion 22, a used maintenance liquid may be discarded, and/or water may be evaporated from the maintenance liquid 21 during the maintenance due to repeated use thereof. In the case as described above, the volume of the maintenance liquid 21 in the tank 24 may also be measured by a sensor 25. As the sensor, for example, a conductivity sensor may be used.

In addition, when the maintenance liquid 21 is decreased, evaporation of a component other than the water can be suppressed by the use of a moisturizing agent component which is not likely to be evaporated; however, the component is condensed by the evaporation of the water. Hence, in this embodiment, there may be provided a mechanism to prevent (recover) the condensation of the maintenance liquid by supplying water to the maintenance liquid for mixing and dilution thereof. For example, when the maintenance liquid 21 is decreased to a certain extent, water may be supplied to the tank 24 from a tank 26 in which water 27 is stored. Alternatively, a new maintenance liquid may also be supplied from the maintenance liquid container.

In addition, for example, the conductivity sensor 25 may be provided not only in the maintenance liquid tank 24 to store and supply the maintenance liquid but also in the cap portion 22, a maintenance liquid supply path, the maintenance liquid pack, and/or the like.

As described above, since the maintenance liquid is provided so as to collectively cover the nozzles of the ink jet head to eject at least two types of inks, and all the nozzles can be simultaneously moisturized, compared to the case in which caps are provided for the respective inks, the recording apparatus can be simplified, and the space therefor can be reduced.

On the other hand, since the maintenance liquid and the ink are different from each other in terms of moisture absorption rate, when the concentration of the moisturizing agent in the maintenance liquid is excessively high or low as compared to that of the ink to be used, an increase or a decreased of moisture in the ink in the vicinity of the nozzle is generated during the maintenance. Since the change in composition occurs, in particular, for example, the clogging recovery property may be degraded, and/or the flight bending of an ejected ink may be liable to occur.

In particular, when at least two types of inks are used, the degrees of increase or decrease of moisture thereof may be different from each other. As a result, although a certain maintenance liquid is preferable for one ink since the increase or decrease of moisture is not generated, the same maintenance liquid as described above may not be preferable for another ink since the increase or decrease of moisture is generated. However, as described above, when the nozzles to eject at least two inks are collectively covered in order to reduce the space and the like, at least two types of maintenance liquids cannot be used for the respective inks. Hence, a maintenance liquid preferable for at least two types of inks is required to be designed.

Accordingly, in this embodiment, since the content A (percent by mass) of the moisturizing agent component with respect to the total mass of the moisturizing agent component and the water satisfies the above Equation (1), the content of the moisturizing agent in the maintenance liquid is optimized for the ink compositions as described above, and as a result, the changes in composition of the inks can be suppressed.

Hereinafter, the components of the maintenance liquid of this embodiment will be described in detail.

Hereinafter, the composition of the maintenance liquid will be described. When the composition of the maintenance liquid is discussed, unless otherwise particularly described, the maintenance liquid indicates a new maintenance liquid to be supplied into the tank of the recording apparatus from the maintenance liquid container or the like.

### 1.1. Moisturizing Agent Component

The maintenance liquid of this embodiment includes a moisturizing agent component containing at least one type of moisturizing agent. In this embodiment, the moisturizing agent indicates one discrete compound, and the moisturizing agent component indicates all the moisturizing agents contained therein. In addition, the moisturizing agent component is a water-soluble organic compound.

The moisturizing agent is an organic compound which can impart a moisturizing property to a water-based composition. Since being contained in a water-based composition, compared to the case in which no moisturizing agent is contained, the moisturizing agent, which is an organic compound, can suppress the evaporation of the water in the composition.

As the moisturizing agent, an organic solvent or an organic compound in the form of a solid at 25° C. may be mentioned. In addition, the organic compound in the form of a solid at 25° C. is a single organic compound in the form of a solid at 25° C. (ordinary temperature) and ordinary pressure.

As the organic solvent, for example, a polyol, a glycol ether, a nitrogen-containing solvent, or a monoalcohol may be mentioned. The organic solvent is preferably a water-soluble organic compound having a standard boiling point of 130° C. or more. The standard boiling point of the organic solvent is more preferably 170° C. to 350° C., further preferably 200° C. to 330° C., and particularly preferably 250° C. to 300° C.

The polyol is an organic compound having at least two hydroxy groups in its molecule. A polyalkylene glycol in which hydroxy groups of molecules are intermolecular condensed may also be used.

Although the polyol is not particularly limited, for example, there may be mentioned diethylene glycol, triethylene glycol, tetraethylene glycol, pentamethylene glycol, trimethylene glycol, 2-butene-1,4-diol, 2-ethyl-1,3-hexanediol, 2-methyl-2,4-pentanediol, propylene glycol, dipropylene glycol, tripropylene glycol, isobutylene glycol, glycerin, diglycerin, meso-erythritol, trimethylolpropane, pentaerythritol, or dipentaerythritol.

The glycol ether is a compound in which one or two hydroxy groups of a polyol molecule having two hydroxy groups in its molecule are etherified, and for example, a glycol monoether or a glycol diether may be mentioned. The etherification is preferably alkyl etherification.

The nitrogen-containing solvent is an organic solvent having a nitrogen atom in its molecule, and for example, an amide or an organic solvent other than the amide may be mentioned. As the amide, for example, an acyclic amide or a cyclic amide may be mentioned, and the cyclic amide includes a lactam functioning as an organic solvent which will be described later.

The monoalcohol is a compound in which one hydroxy group is bonded to an alkane skeleton. As the organic compound in the form of a solid at 25° C., for example, a betaine or an organic compound having at least two hydroxy groups in its molecule may be mentioned.

Although the betaine is not particularly limited, for example, glycine, trimethylglycine, γ-butyrobetaine, or carnitine may be mentioned.

As the organic compound having at least two hydroxy groups in its molecule, a saccharide or an organic compound other than the saccharide may be mentioned.

Although the lactam is not particularly limited, for example, there may be mentioned a lactam, such as 2-pyrrolidone, N-methyl-2-pyrrolidone, N-ethyl-2-pyrrolidone, 1-(2-hydroxyethyl)-2-pyrrolidone, or ε-caprolactam. Some lactam may function as an organic solvent. Some lactam may be a single organic compound in the form of a solid at ordinary temperature.

Although the moisturizing agent is not particularly limited, for example, a polyol, a betaine, or a lactam may be preferably mentioned. The moisturizing agent may be used alone, or at least two types thereof may be used in combination.

The moisturizing agent component preferably contains at least one selected from the group consisting of a water-soluble organic compound which is an organic solvent having a standard boiling point of 130° C. or more and a water-soluble organic compound in the form of a solid at 25° C.

Although the water-soluble organic compound which is an organic solvent having a standard boiling point of 130° C. or more is not particularly limited, for example, an organic compound selected from the above organic solvents may be used, an organic compound appropriately selected from the polyol, the lactam, or the like may be preferably used, and the polyol is more preferable.

Although the single water-soluble organic compound in the form of a solid at 25° C. is not particularly limited, for example, an organic compound selected from those mentioned above may be used, and in particular, an organic compound appropriately selected from the betaines mentioned above is preferably used.

The content A (percent by mass) of the moisturizing agent component with respect to the total mass of the moisturizing agent component and the water satisfies the following Equation (1).

Xₘᵢₙ−5≤A≤Xₘₐₓ+5 Equation (1)

In addition, when the following procedures 1 to 3 are performed, Xₘᵢₙ and Xₘₐₓ are each a value defined by the following definition 1.

### Procedure 1

At least three types of liquid compositions (hereinafter, also referred to as P₁, P₂, P₃, . . . Pₙ, and n represents an integer of 3 or more) each formed from a moisturizing agent component and water, contents B (percent by mass) of the moisturizing agent components each with respect to a total mass of the moisturizing agent component and the water being different from each other, and the at least two types of water-based ink compositions (hereinafter, also referred to as Q₁, Q₂, . . . Qₘ, and m represents an integer of 2 or more) are prepared. The moisturizing agent component of the liquid composition has the same composition as that of the moisturizing agent component included in the maintenance liquid.

Subsequently, a container α in which the liquid composition P₁ is received and a container β in which the ink Q₁ is received, the mass thereof being the same as that of the liquid composition P₁, are left still in a tightly closed container in an environment at a temperature of 25° C. and a relative humidity of 50%. In addition, based on the change in mass of the liquid composition P₁ with time, a moisture absorption rate (g/h) of the liquid composition P₁ to the ink Q₁ is calculated.

In a manner similar to that described above, a moisture absorption rate (g/h) of the ink Q₁ to the liquid composition P₁ is also calculated.

Next, except for that the liquid composition P₁ is changed, the above operation is performed on each of the liquid compositions P₂, P₃, . . . Pₙ under conditions similar to the above conditions. Accordingly, the moisture absorption rates of the liquid compositions and n types of moisture absorption rates of the ink Q₁ corresponding thereto are calculated.

### Procedure 2

In a graph in which the vertical axis indicates the moisture absorption rate, and the horizontal axis indicates the content B of the moisturizing agent component of the liquid composition, after the moisture absorption rates (g/h) of the liquid compositions and the n types of moisture absorption rates (g/h) of the ink Q₁ corresponding thereto are plotted with the content B, an approximate straight line of the moisture absorption rates (g/h) of the liquid compositions and an approximate straight line of the n types of moisture absorption rates (g/h) of the ink Q₁ are formed, respectively.

In addition, a content B located at a point at which the approximate straight line of the moisture absorption rates (g/h) of the liquid compositions and the approximate straight line of the n types of moisture absorption rates (g/h) of the ink Q₁ are intersected to each other is represented by X₁.

### Procedure 3

Except for that the ink Q₁ is changed, the procedures 1 and 2 are performed on each of the inks Q₂ . . . Qₘ under conditions similar to the above conditions. As a result, X₁, X₂, . . . Xₘ are obtained.

### Definition 1

Among X's (X₁, X₂, . . . Xₘ) thus obtained, the maximum value is represented by Xₘₐₓ, and the minimum value is represented by Xₘᵢₙ.

In other words, the procedures described above include a step (procedure 1) to identify the moisture absorption rates of the liquid compositions to one type of water-based ink composition i and the moisture absorption rates of the water-based ink composition i to the liquid compositions; a step (procedure 2) to identify, from the correlation between the content B of the moisturizing agent component and the moisture absorption rates obtained in the procedure 1, a content Xᵢ of the moisturizing agent component at the point at which the moisture absorption rate of the water-based ink composition I and that of the liquid composition are balanced; and a step (procedure 3) to identify contents Xᵢ's of the moisturizing agent components for the respective types of water-based ink compositions and to identify Xₘᵢₙ and Xₘₐₓ among the contents Xᵢ's thus obtained.

In this embodiment, in order to design a preferable maintenance liquid for at least two types of inks, based on Xₘᵢₙ and Xₘₐₓ identified by the above procedures, the content A of the maintenance liquid is determined by the following Equation (1). Accordingly, a maintenance liquid which is not likely to generate the change in composition of all the inks can be prepared.

Xₘᵢₙ−5≤A≤Xₘₐₓ+5 Equation (1)

In addition, in the above Equation, the reason the lower limit and the upper limit are set to “Xₘᵢₙ−5” and “Xₘₐₓ+5”, respectively, will be described. First, the case in which one type of ink Qₘ is moisturized is supposed. In the case described above, by the procedures 1 and 2, Xₘ is assumed to be obtained. In this case, it is believed that the content A of the moisturizing agent component suitable for the maintenance liquid is not only Xₘ but is also in a range of Xₘ±5%.

Since the case in which at least two types of inks are moisturized is also similar to that described above, in the above Equation (1), the lower limit and the upper limit are set to “Xₘᵢₙ−5” and “Xₘₐₓ+5”, respectively. In addition, when the case in which two types of inks, Q₁ and Q₂, are moisturized is supposed, and even when X₁ and X₂ obtained by the procedures 1 and 2 described above are the same, it is believed that the obtained value ±5% is an appropriate value.

In the Procedure 1, n is 3 or more and may also be 4 or more.

In addition, in the procedure 1, when at least three types of liquid compositions are arranged in the order of higher to lower content B of the moisturizing agent component, although the difference (Pₙ−Pₙ₋₁) in the content B (percent by mass) of the moisturizing agent component between the liquid compositions adjacent to each other is not particularly limited, the difference described above may be independently set to 10 percent by mass or more, 15 percent by mass or more, 20 percent by mass or more, or 25 percent by mass or more. An upper limit of the difference described above may be set, for example, to 30 percent by mass or less or 25 percent by mass or less.

In addition, in the at least three types of liquid compositions, a combination between a liquid composition having a positive moisture absorption rate and a water-based ink composition having a negative moisture absorption rate and a combination between a liquid composition having a negative moisture absorption rate and a water-based ink composition having a positive moisture absorption rate are intentionally prepared.

In addition, “the moisturizing agent component of the liquid composition has the same composition as that of the moisturizing agent component contained in the maintenance liquid” indicates the case in which the type of moisturizing agent contained in the moisturizing agent component of the liquid composition is set to the same as that of the moisturizing agent contained in the moisturizing agent component of the maintenance liquid and also indicates the case in which when the maintenance liquid contains at least two types of moisturizing agents as the moisturizing agent component, at least two types of moisturizing agents contained in the liquid composition are set to the same as those in the maintenance liquid, and a composition ratio between the at least two types of moisturizing agents in the liquid composition is also set to the same as the composition ratio between the moisturizing agents in the maintenance liquid. In addition, although the contents B (percent by mass) of the moisturizing agent components in the liquid compositions are different from each other, the composition ratio between the at least two types of moisturizing agents is set to the same therebetween. The composition ratio between the at least two types of the moisturizing agents is a mass ratio between the moisturizing agents with respect to the total mass thereof.

Furthermore, in the above procedure 1, when the change in mass with time is calculated, the measurement intervals may be independently set to every 24 hours. For example, the measurement may be performed from the start with 24 hours intervals. In addition, the measurement is performed at a point at which the change in mass with time is continued.

Next, the state in which the container α and the container β are left still in one tightly closed container is conceptually shown in FIG. 2. As shown in FIG. 2, a gas in the tightly closed container and a gas outside the tightly closed container are not allowed to pass therethrough. In addition, although the container a, the container β, and the tightly closed container are not particularly limited, for example, the containers used in Example which will be described later may be used.

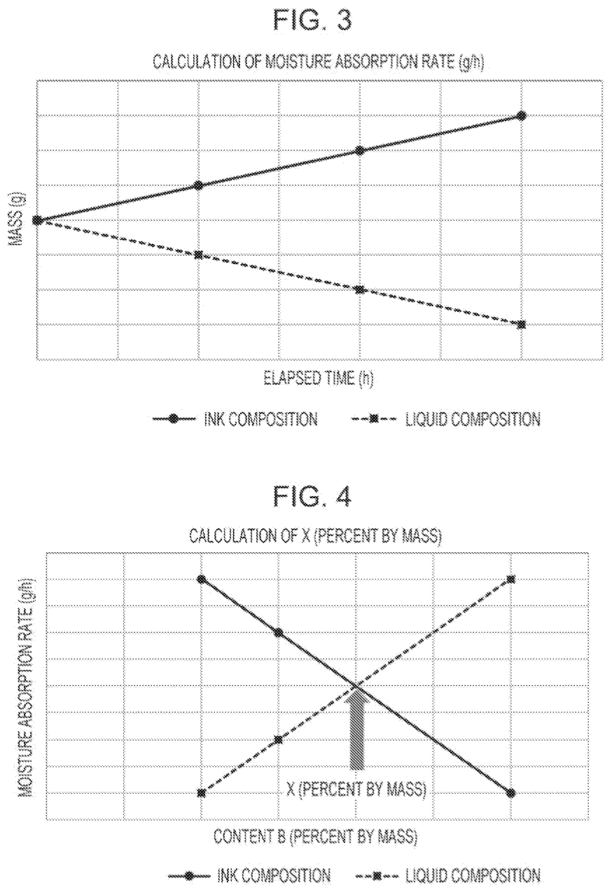

In the above procedure 1, FIG. 3 is a conceptual view showing a calculation method of the moisture absorption rate (g/h) of the liquid composition to the water-based ink composition and the moisture absorption rate (g/h) of the water-based ink composition to the liquid composition.

The graph shown in FIG. 3 is a graph in which the horizontal axis indicates an elapsed time (h) starting from a point at which the container receiving the liquid composition and the container receiving the ink composition, the mass thereof being the same as that of the liquid composition, are left still in the tightly closed container, and the vertical axis indicates the mass (g) of the ink composition and the mass of the liquid composition.

The slope of the solid line in FIG. 3 shows the moisture absorption rate (g/h) of the ink composition, and the slop of the dotted line shows the moisture absorption rate (g/h) of the liquid composition.

In FIG. 3, the mass of the ink composition is gradually increased, and the mass of the liquid composition is decreased. This graph shows an example in which the moisture absorption rate of the ink composition is higher than that of the liquid composition. That is, this graph shows that the ink composition absorbs moisture in the liquid composition.

In the case described above, the moisture absorption rate of the water-based ink composition has a positive value, and the moisture absorption rate of the liquid composition has a negative value.

In addition, when the moisture absorption rate of the liquid composition is higher than the moisture absorption rate of the ink composition, the relationship between the ink composition and the liquid composition shown in FIG. 3 is reversed. In addition, when the moisture absorption rate of the ink composition is approximately equal to the moisture absorption rate of the liquid composition, the masses thereof are not changed.

In the above procedure 2, in the case in which three types of liquid compositions are used, a calculation method to obtain the point X is conceptually shown in FIG. 4. That is, from an approximate straight line obtained by plotting the moisture absorption rates (g/h) of the liquid compositions and an approximate straight line obtained by plotting three types of moisture absorption rates (g/h) of the water-based ink composition corresponding thereto, a point X at which those approximate straight lines are intersected to each other is calculated.

The graph shown in FIG. 4 is a graph in which the horizontal axis indicates the content B (percent by mass) of the moisturizing agent component with respect to the total mass of the moisturizing agent component and the water, and the vertical axis indicates the moisture absorption rates (g/h) of the ink composition and the liquid composition. The solid line in FIG. 4 indicates the moisture absorption rate (g/h) of the ink composition, and the dotted line indicates the moisture absorption rate (g/h) of the liquid composition. In addition, the intersection between the solid line and the dotted line indicates X (percent by mass).

In FIG. 4, the moisture absorption rate (g/h) of the ink composition and the moisture absorption rate (g/h) of the liquid composition are balanced at X (percent by mass). That is, X (percent by mass) represents a content B (percent by mass) at which no change in composition of the ink composition occurs.

In addition, when at least two types of ink compositions are used, X (percent by mass) is obtained from each ink composition.

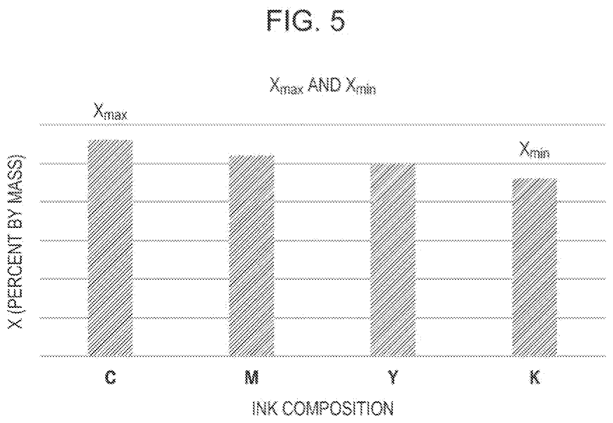

In the definition 1, when three types of liquid compositions are used, and four types of water-based ink compositions are used, among X's (X₁, X₂, - - - Xₘ) obtained as described above, Xₘₐₓ which is maximum and Xₘᵢₙ which is minimum are conceptually shown in FIG. 5.

The graph shown in FIG. 5 is a graph in which the horizontal axis indicates the type of ink composition, and the vertical axis indicates X (percent by mass) of the ink composition.

The bar graph in FIG. 5 shows X's (percent by mass) of the four types of ink compositions.

In FIG. 5, among X's (percent by mass) of the four types of ink compositions, the maximum X (percent by mass) is represented by Xₘₐₓ (percent by mass), and the minimum X (percent by mass) is represented by Xₘᵢₙ (percent by mass).

In addition, in FIG. 5, although Xₘₐₓ (percent by mass) and Xₘᵢₙ (percent by mass) of the four types of ink compositions are shown, even when the number of types of ink compositions is two to three or five or more, Xₘₐₓ (percent by mass) and Xₘᵢₙ (percent by mass) can also obtained in a manner similar to that described above.

In order to suppress the changes in composition of the ink compositions used for the ink jet recording, the content A (percent by mass) of the moisturizing agent component of the maintenance liquid of this embodiment preferably satisfies the following Equation (2).

Xₘᵢₙ≤A≤Xₘₐₓ Equation (2)

In order to further suppress the changes in composition of the ink compositions used for the ink jet recording, the content A (percent by mass) of the moisturizing agent component of the maintenance liquid of this embodiment more preferably satisfies the following Equation (3).

Xₘᵢₙ+[(Xₘₐₓ−Xₘᵢₙ)/4]≤A≤Xₘₐₓ−[(Xₘₐₓ−Xₘᵢₙ)/4] Equation (3)

As for the relationship between Xₘₐₓ and Xₘᵢₙ, in order to suppress the changes in composition of the ink compositions used for the ink jet recording, a value (percent by mass) obtained by subtracting Xₘᵢₙ from Xₘₐₓ is preferably 15 percent by mass or less. In the case described above, the change in composition of each ink can be preferably further suppressed.

In addition, the value described above is preferably 1.0 percent by mass or more and more preferably 2.0 percent by mass or more. In the case described above, the degree of freedom in ink design is preferably high. For example, as the at least two types of inks, when inks having different compositions are used because of the different functions therebetween, the degree of freedom in design is preferably high. The value described above is more preferably 2.0 to 15 percent by mass and further preferably 3.0 to 8.0 percent by mass.

In addition, when a nozzle surface having nozzles to eject at least two types of ink compositions is moisturized by capping using one cap portion, since the nozzles to eject at least two types of ink compositions are present in a closed space, the closed space is not only moisturized by the maintenance liquid but is also moisturized by the at least two types of ink compositions. As a result, since the inks are moisturized with each other, the at least two types of inks are each believed to be preferably moisturized.

Although the content A (percent by mass) of the moisturizing agent component is a content (percent by mass) of the moisturizing agent component with respect to the total mass of the moisturizing agent component and the water of the maintenance liquid and satisfies the above Equation (1), for example, the content A is preferably 10 to 40 percent by mass, more preferably 15 to 35 percent by mass, and further preferably 20 to 30 percent by mass.

### 1.2. Water

Although the water contained in the maintenance liquid of this embodiment is not particularly limited, for example, there may be mentioned ion exchange water, ultrafiltration water, reverse osmosis water, or distilled water. The maintenance liquid is a water-based composition. The water-based composition is a composition in which the solvent component contains at least water as a primary component.

A content of the water with respect to the total mass of the maintenance liquid is preferably 45 percent by mass or more, more preferably 50 to 95 percent by mass, even more preferably 55 to 87.5 percent by mass, further preferably 60 to 85 percent by mass, even further preferably 65 to 82.5 percent by mass, and particularly preferably 70 to 80 percent by mass.

### 1.3. Antiseptic Agent

Although the antiseptic agent is not particularly limited, for example, there may be mentioned a chelating agent, such as ethylenediaminetetraacetic acid salt (EDTA); sodium benzoate, sodium pentachlorophenol, sodium 2-pyridinethiol-1-oxide, sodium sorbate, sodium dehydroacetate, 1,2-dibenzoisothiazolin-3-on, or 4-chloro-3-methylphenol. The antiseptic agent may be used alone, or at least two types thereof may be used in combination.

A content of the antiseptic agent with respect to the total mass of the maintenance liquid is preferably 0.01 to 1.0 percent by mass, more preferably 0.05 to 0.8 percent by mass, even more preferably 0.1 to 0.6 percent by mass, and further preferably 0.2 to 0.4 percent by mass.

### 1.4. Other Components

The maintenance liquid of this embodiment may contain, besides the components described above, known other components which can be used for the maintenance liquid. Although the other components as described above are not particularly limited, for example, there may be mentioned a solubilizing agent, a viscosity adjuster, a pH adjuster, an antioxidant, a corrosion inhibitor, a moisturizing agent component other than that described above, and/or an antiseptic agent other than that described above. Those components may be used alone, or at least two types thereof may be used in combination.

### 2. Water-Based Ink Composition

The water-based ink composition (hereinafter, also simply referred to as “ink composition” in some cases) of this embodiment is used to be ejected from the ink jet head of the recording apparatus of this embodiment. In this embodiment, at least two types of ink compositions are used in combination. In addition, the ink composition of this embodiment may also contain a colorant and, in addition, may also contain, if needed, other components.

### 2.1. Colorant

Although the colorant is not particularly limited, for example, a dye and/or a pigment may be mentioned, and among those mentioned above, since being applicable to various types of recording media and having a discoloration resistance against light, gas, and the like, a pigment is preferably used.

Although the pigment is not particularly limited, for example, there may be mentioned an azo pigment (such as an azo lake, an insoluble azo pigment, a condensed azo pigment, or a chelating azo pigment; a polycyclic pigment (such as a phthalocyanine pigment, a perylene pigment, a perinone pigment, an anthraquinone pigment, a quinacridone pigment, a dioxazine pigment, a thioindigo pigment, an isoindolinone pigment, or a quinophthalone pigment); an organic pigment, such as a nitro pigment, a nitroso pigment, or an aniline black; a carbon black (such as a furnace black, a thermal lamp black, an acetylene black, or a channel black); an inorganic pigment, such as a metal oxide, a metal sulfide, or a metal chloride; or an extender pigment, such as a silica, calcium carbonate, or a talk. The pigment may be used alone, or at least two types thereof may be used in combination.

A content of the colorant in the ink is preferably 0.5 percent by mass or more, more preferably 1.0 to 15.0 percent by mass and further preferably 5 to 10 percent by mass.

A content of the colorant in at least one of the at least two types of ink compositions with respect to the total mass of the ink composition is preferably 7.0 percent by mass or more, more preferably 7.0 to 15.0 percent by mass, even more preferably 7.0 to 10 percent by mass, further preferably 7.5 to 9.5 percent by mass, and particularly preferably 8.0 to 9.0 percent by mass.

### 2.2. Water

Although the water contained in the ink composition of this embodiment is not particularly limited, for example, there may be mentioned ion exchange water, ultrafiltration water, reverse osmosis water, or distilled water.

The ink composition is a water-based composition. A content of the water with respect to the total mass of the ink composition is preferably 40.0 percent by mass or more, more preferably 45.0 to 98.0 percent by mass, even more preferably 47.5 to 82.5 percent by mass, further preferably 50 to 80 percent by mass, particularly preferably 52.5 to 77.5 percent by mass, and more particularly preferably 55 to 75 percent by mass.

### 2.3. Inorganic Oxide Particles

The ink composition of this embodiment preferably contains inorganic oxide particles. Although the inorganic oxide particles are not particularly limited, for example, a colloidal silica or an alumina colloid may be mentioned. The inorganic oxide particles may be surface-treated, and although not particularly limited, for example, a colloidal silica may be surface-treated with alumina. The inorganic oxide particles may be used alone, or at least two types thereof may be used in combination.

A content of the inorganic oxide particles with respect to the total mass of the ink composition is preferably 0.1 to 7.0 percent by mass, more preferably 0.5 to 6.0 percent by mass, even more preferably 1.0 to 5.0 percent by mass, and further preferably 2.0 to 4.0 percent by mass.

### 2.4. Organic Solvent

The ink composition of this embodiment may also contain, independently of the maintenance liquid described above, a moisturizing agent which may also be included in the maintenance liquid described above. An organic solvent is preferably contained. The moisturizing agent is not particularly limited, and for example, a polyol, a glycol ether, a lactam, or a betaine may be mentioned. The moisturizing agent may be used alone, or at least two types thereof may be used in combination.

Although the polyol is not particularly limited, for example, there may be mentioned diethylene glycol, triethylene glycol, tetraethylene glycol, pentamethylene glycol, trimethylene glycol, 2-butene-1,4-diol, 2-ethyl-1,3-hexanediol, 2-methyl-2,4-pentanediol, propylene glycol, dipropylene glycol, tripropylene glycol, isobutylene glycol, glycerin, diglycerin, meso-erythritol, trimethylolpropane, pentaerythritol, or dipentaerythritol.

Although the glycol ether is not particularly limited, for example, there may be mentioned ethylene glycol monomethyl ether, ethylene glycol monoethyl ether, ethylene glycol monopropyl ether, ethylene glycol monobutyl ether, ethylene glycol monomethyl ether acetate, diethylene glycol monomethyl ether, diethylene glycol monoethyl ether, diethylene glycol monopropyl ether, diethylene glycol monobutyl ether, diethylene glycol mono-t-butyl ether, triethylene glycol monoethyl ether, triethylene glycol monobutyl ether, 1-methyl-1-methoxyputanol, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, propylene glycol monobutyl ether, or dipropylene glycol monobutyl ether.

The lactam is not particularly limited, and for example, a lactam, such as 2-pyrrolidone, N-methyl-2-pyrolidone, ε-caprolactam, or hydroxyethyl pyrrolidone may be mentioned.

The betaine is not particularly limited, and for example, glycine, trimethylglycine, γ-butyrobetaine, or carnitine may be mentioned.

In this embodiment, at least one of the at least two types of ink compositions more preferably contains a water-soluble organic compound which is an organic solvent having a standard boiling point of 130° C. or more and/or a water-soluble organic compound in the form of a solid at 25° C.

The water-soluble organic compound which is an organic solvent having a standard boiling point of 130° C. or more is not particularly limited, and for example, an organic compound appropriately selected from the polyols and the lactams mentioned above may be used, and although the water-soluble organic compound in the form of a solid at 25° C. is not particularly limited, for example, an organic compound appropriately selected from the betaines mentioned above may be used.

A content of the organic solvent with respect to the total mass of the ink composition is preferably 10 to 40 percent by mass, more preferably 15 to 35 percent by mass, and further preferably 20 to 30 percent by mass.

### 2.5. Surfactant

The ink composition of this embodiment preferably contains a surfactant, and although the surfactant is not particularly limited, for example, an acetylene glycol-based surfactant, a silicone-based surfactant, or a fluorine-based surfactant may be mentioned. The surfactant may be used alone, or at least two types thereof may be used in combination.

The acetylene glycol-based surfactant is not particularly limited, and for example, 2,4,7,9-tetramethyl-5-decyne-4,7-diol, an alkylene oxide adduct thereof, 2,4-dimethyl-5-decyne-4-ol, or an alkylene oxide adduct thereof may be mentioned.

The silicone-based surfactant is not particularly limited, and for example, a polysiloxane-based compound or a polyether-modified organosiloxane may be mentioned.

The fluorine-based surfactant is not particularly limited, and for example, there may be mentioned a perfluoroalkyl sulfonate, a perfluoroalkyl carboxylate, a perfluoroalkyl phosphoric acid ester, a perfluoroalkyl ethylene oxide adduct, a perfluoroalkyl betaine, or a perfluoroalkylamine oxide compound.

A content of the surfactant with respect to the total mass of the ink composition is preferably 0.1 to 2.5 percent by mass, more preferably 0.3 to 2.0 percent by mass, even more preferably 0.4 to 1.5 percent by mass, and further preferably 0.5 to 1.0 percent by mass.

### 2.6. Other Components

The ink composition of this embodiment may contain, besides the components described above, known other components which can be used for related ink compositions. Although the other components as described above are not particularly limited, for example, there may be mentioned a solubilizing agent, a viscosity adjuster, a pH adjuster, an antioxidant, an antiseptic agent, a corrosion inhibitor, a chelating agent to trap predetermined metal ions having an influence on the dispersion, other additives, and/or an organic solvent other than that described above. Those other components may be used alone, or at least two types thereof may be used in combination.

### 3. Ink Set

The maintenance liquid of this embodiment may also be used as an ink set including the maintenance liquid of this embodiment and the ink composition of this embodiment. In addition, the ink set indicates a combination including a maintenance liquid, an ink composition, and the like which are used together for the ink jet recording. The ink composition indicates at least two types of ink compositions to be used by being ejected from an ink jet head in which the maintenance is performed by the maintenance liquid.

### 4. Maintenance Method

A maintenance method of this embodiment includes a maintenance step of supplying the maintenance liquid described above to a cap portion which covers a nozzle surface of an ink jet head of a recording apparatus so as to moisturize the nozzle surface and may also include other steps, if needed.

In addition, the maintenance method of this embodiment may further include, prior to the maintenance step, an ejection step of ejecting the ink jet ink described above using a predetermined ink jet head so as to be adhered to a recording medium.

### 4.1. Ejection Step

In the ejection step, the ink ejected from the ink jet head is adhered to a recording medium. In more particular, a pressure generator provided in the ink jet head is driven, and the ink filled in a pressure generation room of the ink jet head is ejected from a nozzle. The ejection method as described above is also called an ink jet method.

As the ink jet head used in the ejection step, a line head to perform recording by a line method and a serial head to perform recording by a serial method may be mentioned.

In the line method using a line head, for example, an ink jet head having a width larger than a recording width of a recording medium is fixed to a recording apparatus. Subsequently, the recording medium is transferred in a sub-scanning direction (transport direction of the recording medium), and in conjunction with this transfer, ink droplets are ejected from nozzles of the ink jet head, so that an image is recorded on the recording medium.

In the serial method using a serial head, for example, the ink jet head is mounted on a carriage which can be transferred in a width direction of a recording medium. In addition, the carriage is transferred in a main scanning direction (width direction of the recording medium), and in conjunction with this transfer, ink droplets are ejected from nozzles of the ink jet head, so that an image is recorded on the recording medium.

### 4.2. Maintenance Step

The maintenance step is a step to perform maintenance of the ink jet head using the maintenance liquid described above. A maintenance method for the ink jet head is not particularly limited, and for example, the maintenance liquid may be either indirectly or directly supplied to the nozzle surface of the ink jet head.

When being directly supplied, the maintenance liquid may be adhered to the nozzle surface. In addition, when the maintenance liquid is indirectly supplied, there may be mentioned a method in which the maintenance liquid is supplied to a cap which covers the nozzle surface of the ink jet head to form a closed space between this nozzle surface and the cap, and the closed space thus formed is moisturized by the maintenance liquid which is not in contact with the nozzle surface.

In addition, the maintenance method of this embodiment may also include a step of detecting the conductivity of the maintenance liquid by a conductivity sensor. The step of detecting the conductivity is a step to detect the conductivity of the maintenance liquid by a conductivity sensor. The conductivity sensor is provided in the tank in which the maintenance liquid is stored, and the water level thereof may be measured by the conductivity. For example, the conductivity sensors are provided at predetermined water levels of the tank, and when the conductivity is detected by the sensors described above, the maintenance liquid is confirmed to be stored at the water level at which the conductivity is detected.

When the conductivity of the maintenance liquid is not detected, or when the volume of the maintenance liquid is found to be small as a result of the detection of the conductivity of the maintenance liquid, water may be supplied to the maintenance liquid from the tank in which water is stored.

### 5. Recording Apparatus

The recording apparatus of this embodiment includes a maintenance liquid and an ink jet head in which the nozzle surface is moisturized as described above by the maintenance liquid. The ink jet head is a head to perform recording by ejecting at least two types of water-based ink compositions and has a nozzle surface in which nozzles to eject the water-based ink compositions are formed. In addition, in the nozzle surface described above, nozzles are formed for the respective at least two types of water-based ink compositions.

In addition, the recording apparatus of this embodiment may also include a supply mechanism to supply the maintenance liquid described above, and this supply mechanism may further include a water supply mechanism to supply water to the maintenance liquid.

Although not particularly limited, for example, the recording apparatus may further include a transport device to transport a recording medium, a conductivity sensor used for detection of the conductivity of the maintenance liquid, and the like. The transport device described above is formed from a transport roller or a transport belt provided in the recording apparatus.

### 6. Recording Medium

Although a recording medium used in this embodiment is not particularly limited, for example, an absorbing, a low-absorbing, or a non-absorbing recording medium may be mentioned.

The absorbing recording medium is not particularly limited, and for example, there may be mentioned regular paper, such as electrophotographic paper, having a high ink permeability, or ink jet paper (ink jet exclusive paper having an ink absorbing layer formed from silica particles or alumina particles or an ink absorbing layer formed from a hydrophilic polymer, such as a polyvinyl alcohol (PVA) or a polyvinyl pyrrolidone (PVP)).

As the low-absorbing recording medium, for example, there may be mentioned art paper, coated paper, or cast paper each of which has a relatively low ink permeability and is used for general offset printing.

The non-absorbing recording medium is not particularly limited, and for example, there may be mentioned a film or a plate formed from a plastic, such as a poly(vinyl chloride), a polyethylene, a polypropylene a poly(ethylene terephthalate) (PET), a polycarbonate, a polystyrene, or a polyurethane; a plate formed from a metal, such as iron, silver, copper, or aluminum; a metal plate or a plastic-made film manufactured by deposition of at least one of the metals mentioned above; an alloy plate formed from stainless steel, brass, or the like; or a recording medium in which a film of a plastic, such as a poly(vinyl chloride), a polyethylene, a polypropylene a poly(ethylene terephthalate) (PET), a polycarbonate, a polystyrene, or a polyurethane, is adhered (coated) to a paper-made substrate.

### EXAMPLES

Hereinafter, the present disclosure will be described in more detail with reference to Examples and Comparative Examples. However, the present disclosure is not at all limited to the following Examples.

### 1. Preparation of Ink Set and Maintenance Liquid

In order to have the compositions shown in Table 5, after components were charged in a mixing tank, mixing and stirring were performed, and filtration using a membrane filter was further performed, so that ink sets A to C including respective ink compositions were prepared. In order to have the compositions shown in Tables 1 to 4, after components were charged in a mixing tank, mixing and stirring were performed, and filtration using a membrane filter was further performed, so that maintenance liquids of Examples and Comparative Examples were obtained. In addition, unless otherwise particularly described, the numerical value of each component of each Example in the table represents percent by mass. In addition, the contents (percent by mass) of the pigment and the colloidal silica shown in Tables 1 to 5 each represent a solid content concentration.

TABLE 1

| | | | EXAMPLE | | | | | | | |
|---|---|---|---|---|---|---|---|---|---|---|
| | | | 1 | 2 | 3 | 4 | 5 | 6 | 7 | 8 |
| INK SET | | | A | A | A | A | A | A | A | A |
| Xmin | | | 22.5 | | | | | 28.9 | 22.4 | 14.9 |
| Xmax | | | 27.5 | | | | | 35.3 | 27.4 | 18.3 |
| MAINTENANCE | MOISTURIZING | GLYCERIN | 24.9 | 22.5 | 27.4 | 18.5 | 31.4 | | | |
| LIQUID | AGENT | TRIETHYLENE | | | | | | 32.0 | | |
| | | GLYCOL | | | | | | | | |
| | | PROPYLENE GLYCOL | | | | | | | 24.8 | |
| | | TRIMETHYLGLYCINE | | | | | | | | 16.5 |
| | | 1-(2- | | | | | | | | |
| | | HYDROXYETHYL)- | | | | | | | | |
| | | 2-PYRROLIDONE | | | | | | | | |
| | ANTISEPTIC | Proxel XL2 | 0.3 | 0.3 | 0.3 | 0.3 | 0.3 | 0.3 | 0.3 | 0.3 |
| | AGENT | | | | | | | | | |

| | | | | | | | | | |
|---|---|---|---|---|---|---|---|---|---|
| | WATER | 74.8 | 77.3 | 72.3 | 81.3 | 68.3 | 67.7 | 74.9 | 83.2 |
| | TOTAL | 100.0 | 100.0 | 100.0 | 100.0 | 100.0 | 100.0 | 100.0 | 100.0 |
| | MOISTURIZING AGENT | 25.0 | 22.5 | 27.5 | 18.5 | 31.5 | 32.1 | 24.9 | 16.6 |
| | (g)/(MOISTURIZING AGENT(g) + WATER | | | | | | | | |
| | (g)) (WEIGHT BASIS) | | | | | | | | |
| EVALUATION | CHANGE IN INK COMPOSITION WITH | A | B | B | B | B | A | A | A |
| RESULT | MOISTURIZING TIME | | | | | | | | |
| | INK CONSUMPTION BY FLUSHING | A | A | A | B | B | B | B | A |
| | CLOGGING RECOVERY PROPERTY | A | A | B | A | B | A | A | B |
| | CLOGGING RECOVERY PROPERTY IN | A | A | A | A | A | A | A | B |
| | ABNORMAL CONTACT STATE | | | | | | | | |
| | STACKING PROPERTY | A | A | A | A | A | A | A | A |

TABLE 2

| | | | EXAMPLE | | | | | | | |
|---|---|---|---|---|---|---|---|---|---|---|
| | | | 9 | 10 | 11 | 12 | 13 | 14 | 15 | 16 |
| INK SET | | | A | A | A | A | B | B | C | C |
| Xmin | | | 35.9 | 25.1 | | | 20.5 | | 23.5 | |
| Xmax | | | 43.8 | 30.7 | | | 25.5 | | 27.5 | |
| MAINTENANCE | MOISTURIZING | GLYCERIN | | 20.0 | 18.1 | 22.0 | 25.3 | 29.4 | 27.3 | 31.4 |
| LIQUID | AGENT | TRIETHYLENE | | | | | | | | |
| | | GLYCOL | | | | | | | | |
| | | PROPYLENE GLYCOL | | | | | | | | |
| | | TRIMETHYLGLYCINE | | | | | | | | |
| | | 1-(2- | 39.7 | 7.8 | 6.9 | 8.6 | | | | |
| | | HYDROXYETHYL)- | | | | | | | | |
| | | 2-PYRROLIDONE | | | | | | | | |
| | ANTISEPTIC | Proxel XL2 | 0.3 | 0.3 | 0.3 | 0.3 | 0.3 | 0.3 | 0.3 | 0.3 |
| | AGENT | | | | | | | | | |

| | | | | | | | | | |
|---|---|---|---|---|---|---|---|---|---|
| | WATER | 60.0 | 71.9 | 74.7 | 69.1 | 74.4 | 70.3 | 72.4 | 68.3 |
| | TOTAL | 100.0 | 100.0 | 100.0 | 100.0 | 100.0 | 100.0 | 100.0 | 100.0 |
| | MOISTURIZING AGENT | 39.8 | 27.9 | 25.1 | 30.7 | 25.4 | 29.5 | 27.4 | 31.5 |
| | (g)/(MOISTURIZING AGENT(g) + WATER | | | | | | | | |
| | (g)) (WEIGHT BASIS) | | | | | | | | |
| EVALUATION | CHANGE IN INK COMPOSITION WITH | A | A | B | B | B | B | B | B |
| RESULT | MOISTURIZING TIME | | | | | | | | |
| | INK CONSUMPTION BY FLUSHING | B | A | A | A | A | B | A | B |
| | CLOGGING RECOVERY PROPERTY | A | A | A | A | A | B | A | B |
| | CLOGGING RECOVERY PROPERTY IN | B | B | B | B | A | A | A | A |
| | ABNORMAL CONTACT STATE | | | | | | | | |
| | STACKING PROPERTY | A | A | A | A | B | B | A | A |

TABLE 3

| | | | COMPARATIVE EXAMPLE | | | | | | | |
|---|---|---|---|---|---|---|---|---|---|---|
| | | | 1 | 2 | 3 | 4 | 5 | 6 | 7 | 8 |
| INK SET | | | A | A | B | B | C | C | A | A |
| Xmin | | | 22.5 | | 20.5 | | 23.5 | | 28.9 | |
| Xmax | | | 27.5 | | 25.5 | | 27.5 | | 35.3 | |
| MAINTENANCE | MOISTURIZING | GLYCERIN | 16.5 | 33.4 | 14.5 | 31.4 | 17.4 | 33.4 | | |
| LIQUID | AGENT | TRIETHYLENE | | | | | | | 22.8 | 41.2 |
| | | GLYCOL | | | | | | | | |
| | | PROPYLENE GLYCOL | | | | | | | | |
| | | TRIMETHYLGLYCINE | | | | | | | | |
| | | 1-(2- | | | | | | | | |
| | | HYDROXYETHYL)- | | | | | | | | |
| | | 2-PYRROLIDONE | | | | | | | | |
| | ANTISEPTIC | Proxel XL2 | 0.3 | 0.3 | 0.3 | 0.3 | 0.3 | 0.3 | 0.3 | 0.3 |
| | AGENT | | | | | | | | | |

| | | | | | | | | | |
|---|---|---|---|---|---|---|---|---|---|
| | WATER | 83.2 | 66.3 | 85.2 | 68.3 | 82.3 | 66.3 | 76.9 | 58.5 |
| | TOTAL | 100.0 | 100.0 | 100.0 | 100.0 | 100.0 | 100.0 | 100.0 | 100.0 |
| | MOISTURIZING AGENT | 16.5 | 33.5 | 14.5 | 31.5 | 17.5 | 33.5 | 22.9 | 41.3 |
| | (g)/(MOISTURIZING AGENT(g) + WATER | | | | | | | | |
| | (g)) (WEIGHT BASIS) | | | | | | | | |
| EVALUATION | CHANGE IN INK COMPOSITION WITH | C | C | C | C | C | C | C | C |
| RESULT | MOISTURIZING TIME | | | | | | | | |
| | INK CONSUMPTION BY FLUSHING | C | C | C | C | C | C | C | C |
| | CLOGGING RECOVERY PROPERTY | B | C | A | C | A | C | B | C |
| | CLOGGING RECOVERY PROPERTY IN | A | A | A | A | A | A | A | A |
| | ABNORMAL CONTACT STATE | | | | | | | | |
| | STACKING PROPERTY | A | A | B | B | A | A | A | A |

TABLE 4

| | | | COMPARATIVE | | | | | | | |
|---|---|---|---|---|---|---|---|---|---|---|
| | | | EXAMPLE | | REFERENCE EXAMPLE | | | | | |
| | | | 9 | 10 | 1 | 2 | 3 | 4 | 5 | 6 |
| INK SET | | | A | A | INK SET Cy | | | INK SET Bk | | |
| Xmin | | | 14.9 | | 27.5 | | | 22.5 | | |
| Xmax | | | 18.3 | | | | | | | |
| MAINTENANCE | MOISTURIZING | GLYCERIN | | | 21.4 | 27.4 | 33.4 | 16.5 | 22.4 | 28.4 |
| LIQUID | AGENT | TRIETHYLENE GLYCOL | | | | | | | | |
| | | PROPYLENE GLYCOL | | | | | | | | |
| | | TRIMETHYLGLYCINE | 8.9 | 24.2 | | | | | | |
| | | 1-(2-HYDROXYETHYL)- | | | | | | | | |
| | | 2-PYRROLIDONE | | | | | | | | |
| | ANTISEPTIC | Proxel XL2 | 0.3 | 0.3 | 0.3 | 0.3 | 0.3 | 0.3 | 0.3 | 0.3 |
| | AGENT | | | | | | | | | |

| | | | | | | | | | |
|---|---|---|---|---|---|---|---|---|---|
| | WATER | 90.8 | 75.5 | 78.3 | 72.3 | 66.3 | 83.2 | 77.3 | 71.3 |
| | TOTAL | 100.0 | 100.0 | 100.0 | 100.0 | 100.0 | 100.0 | 100.0 | 100.0 |
| | MOISTURIZING AGENT (g)/(MOISTURIZING | 8.9 | 24.3 | 21.5 | 27.5 | 33.5 | 16.5 | 22.5 | 28.5 |
| | AGENT(g) + WATER (g) (WEIGHT BASIS) | | | | | | | | |
| EVALUATION | CHANGE IN INK COMPOSITION WITH | C | C | C | A | C | C | A | C |
| RESULT | MOISTURIZING TIME | | | | | | | | |
| | INK CONSUMPTION BY FLUSHING | C | C | C | A | C | C | A | C |
| | CLOGGING RECOVERY PROPERTY | B | C | B | | | | A | C |
| | CLOGGING RECOVERY PROPERTY IN | B | B | A | A | A | A | A | A |
| | ABNORMAL CONTACT STATE | | | | | | | | |
| | STACKING PROPERTY | A | A | A | A | A | A | A | A |

TABLE 5

| INK SET | | A | | | | B | | | | C | | | |
|---|---|---|---|---|---|---|---|---|---|---|---|---|---|
| COLOR | | C | M | Y | K | C | M | Y | K | C | M | Y | K |
| PIGMENT | CYAN PIGMENT | 5 | | | | 5 | | | | 5 | | | |
| | MAGENTA PIGMENT | | 8.5 | | | | 8.5 | | | | 6.5 | | |
| | YELLOW PIGMENT | | | 7 | | | | 7 | | | | 6 | |
| | BLACK PIGMENT | | | | 7 | | | | 7 | | | | 6 |
| INORGANIC | COLLOIDAL SILICA | 3 | 3 | 3 | 3 | 0 | 0 | 0 | 0 | 3 | 3 | 3 | 3 |
| OXIDE | | | | | | | | | | | | | |
| PARTICLE | | | | | | | | | | | | | |
| ORGANIC | GLYCERIN | 7 | 7 | 5 | 8 | 7 | 7 | 5 | 8 | 7 | 7 | 5 | 8 |
| SOLVENT | TEG | 11 | 6 | 4 | 2 | 11 | 6 | 4 | 2 | 11 | 8 | 5 | 3 |
| | TRIMETHYLGLYCINE | 7 | 7 | 9 | 7 | 7 | 7 | 9 | 7 | 7 | 7 | 9 | 7 |
| | BTG | 1 | 1 | 1 | 1 | 1 | 1 | 1 | 1 | 1 | 1 | 1 | 1 |
| | MTG | 2 | 2 | 2 | 2 | 2 | 2 | 2 | 2 | 2 | 2 | 2 | 2 |
| SURFACTANT | OLFINE E1010 | 0.7 | 0.7 | 0.7 | 0.7 | 0.7 | 0.7 | 0.7 | 0.7 | 0.7 | 0.7 | 0.7 | 0.7 |
| | SURFYNOL 104 | 0.7 | 0.7 | 0.7 | 0.7 | 0.7 | 0.7 | 0.7 | 0.7 | 0.7 | 0.7 | 0.7 | 0.7 |

| | | | | | | | | | | | | |
|---|---|---|---|---|---|---|---|---|---|---|---|---|
| WATER | 62.6 | 64.1 | 67.6 | 68.6 | 65.6 | 67.1 | 70.6 | 71.6 | 62.6 | 64.1 | 67.6 | 68.6 |
| TOTAL | 100 | 100 | 100 | 100 | 100 | 100 | 100 | 100 | 100 | 100 | 100 | 100 |

The materials in Tables 1 to 5 are as shown below.

### Maintenance Liquid

### Moisturizing Agent

glycerin
triethylene glycol
propylene glycol
trimethylglycine
1-(2-hydroxyethyl)-2-pyrrolidone

### Antiseptic Agent

Proxel XL2

### Water

ION EXCHANGE WATER

### Ink Set

### Pigment

cyan pigment: CAB-O-JET 450C (manufactured by Cabot)
magenta pigment: CAB-O-JET 465M (manufactured by Cabot)
yellow pigment: CAB-O-JET 470Y (manufactured by Cabot)
black pigment: CAB-O-JET 400 (manufactured by Cabot)

### Inorganic Oxide Particles

colloidal silica: “Cataloid SI-30” manufactured by Nissan Chemical Corporation

### Solvent

glycerin
triethylene glycol
trimethylglycine
BTG: triethylene glycol monobutyl ether
MTG: triethylene glycol monomethyl ether Surfactant
Olfine E1010 (acetylene glycol-based surfactant, manufactured by Nisshin Chemical Industry Co., Ltd.
Surfynol 104: (acetylene glycol-based surfactant, manufactured by Air Products Japan. Inc.)

### Water

ion exchange water

When the following procedures 1 to 3 were performed, Xₘᵢₙ and Xₘₐₓ shown in Tables 1 to 4 were each defined by the following definition 1.

### Procedure 1

First, three types of liquid compositions (hereinafter, also referred to as P1, P2, and P3) which were liquid compositions each formed from a moisturizing agent component and water and in which contents B (percent by mass) of the moisturizing agent components each with respect to a total mass of the moisturizing agent component and the water were 5.0, 20, and 40 percent by mass, respectively, and four types of water-based ink compositions (hereinafter, also referred to as Q1, Q2, Q3, and Q4) were prepared. When at least two types of moisturizing agents were contained as the moisturizing agent component of the liquid composition, regardless of the content B (percent by mass) of the moisturizing agent component of the liquid composition, the compositions of the at least two types of moisturizing agents are not changed, and the ratio therebetween is also not changed.

Subsequently, a container α in the form of a Schale having a diameter of 35 mm in which the liquid composition P₁ was received and a container β in the form of a Schale having a diameter of 35 mm in which the ink Q₁ was received, the mass thereof being the same as that of the liquid composition P₁, were left still in a tightly closed container having a volume of 506 cm³ in an environment at a temperature of 25° C. and a relative humidity of 50%. In addition, the masses of the container a and the container β were measured 24 hours, 48 hours, and 72 hours after the containers were left still, and based on the change in mass of the liquid composition P₁ with time, a moisture absorption rate (g/h) of the liquid composition P₁ to the ink Q₁ was calculated.

A moisture absorption rate (g/h) of the ink Q₁ to the liquid composition P₁ was also calculated in a manner similar to that described above.

Subsequently, except for that the liquid composition P₁ was changed, the above operation was performed on each of the liquid compositions P₂ and P₃ under conditions similar to the above conditions. Accordingly, the moisture absorption rates of the liquid compositions and three types of moisture absorption rates of the ink Q₁ corresponding thereto were calculated.

### Procedure 2

In a graph in which the vertical axis indicates the moisture absorption rate, and the horizontal axis indicates the content B of the moisturizing agent component of the liquid composition, after the moisture absorption rates (g/h) of the liquid compositions and the three types of moisture absorption rates (g/h) of the ink Q₁ corresponding thereto were plotted with the content B, an approximate straight line of the moisture absorption rates (g/h) of the liquid compositions and an approximate straight line of the three types of moisture absorption rates (g/h) of the ink Q₁ were formed, respectively.

In addition, a content B located at a point at which the approximate straight line of the moisture absorption rates (g/h) of the liquid compositions and the approximate straight line of the three types of moisture absorption rates (g/h) of the ink Q₁ were intersected to each other was represented by X₁.

### Procedure 3

Except for that the ink Q₁ was changed, the procedures 1 and 2 were performed on each of the inks Q₂, Q₃, and Q₄ under conditions similar to the above conditions, so that X₁, X₂, X₃, and X₄ were obtained thereby.

### Definition 1

Among X₁, X₂, X₃, and X₄ thus obtained, the maximum value is represented by Xₘₐₓ, and the minimum value is represented by Xₘᵢₙ.

### 2. Evaluation Method

2.1. Change in Ink Composition with Moisturizing Time

After the ink composition and the maintenance liquid of one ink set were weighed in amounts equivalent to each other and were then charged in respective containers having the same shape (container: Schale having a diameter of 35 mm, liquid weight: 5 g), the ink composition and the maintenance liquid described above were left still in a tightly closed container (container volume: 506 cm³) through which water and water vapor were not allowed to pass in an environment at a temperature of 25° C. and a relative humidity of 50%. After the ink composition and the maintenance liquid described above were left still for 7 days, the change in viscosity of the ink before and after being left still was measured and then evaluated by the following evaluation criteria. The results thus obtained are shown in Tables 1 to 4. The viscosity was measured at 25° C. Among the inks of the ink set, an ink having the worst evaluation result was used for the evaluation.

### Evaluation Criteria

A: rate of change in viscosity (%) is less than 3%.
B: rate of change in viscosity (%) is 3% to less than 5%.
C: rate of change in viscosity (%) is 5% or more.

### 2.2. Ink Consumption by Flushing

As a recording apparatus, an LX-10050MF modified machine manufactured by Seiko Epson Corporation was prepared. The inks of the ink sets of Examples and Comparative Examples were charged in the respective ink jet heads. In the state in which a moisturizing cap was not capped on the ink jet head, the ink jet head was left still for 7 days in an environment at a temperature of 40° C. and a relative humidity of 20%. After the ink jet head was left still for 7 days, the moisturizing cap was filled with the maintenance liquid and was then capped on the ink jet head so that the maintenance liquid was not brought into contact with the nozzle surface of the ink jet head. Next, the ink jet head was left still for 7 days in an environment at a temperature of 40° C. and a relative humidity of 20%. Subsequently, an ink consumption C₁ by flushing required until the ink could be normally ejected from all the nozzles was measured.

In addition, except for that the moisturizing cap was changed to a cap having the same shape (hereinafter, also referred to as “related waste ink cap”) without being filled with the maintenance liquid, an operation similar to that described above was performed, and an ink consumption C₂ by flushing required until the ink could be normally ejected from all the nozzles was measured.

The rate of change in consumption (%) represented by (C₂−C₁)/C₂ was evaluated by the following evaluation criteria. The results are shown in Tables 1 to 4. Among the inks of the ink set, an ink having the worst evaluation result was used for the evaluation.

### Evaluation Criteria

A: rate of change in ink consumption (%) is 20% or more.
B: rate of change in ink consumption (%) is 5% to less than 20%.
C: rate of change in ink consumption (%) is less than 5%, or some nozzle is not recovered.

### 2.3. Clogging Recovery Property

An LX-10050MF modified machine manufactured by Seiko Epson Corporation was prepared. The inks of Examples and Comparative Examples were charged in the respective ink jet heads, and all the nozzles were confirmed to eject the inks. Subsequently, in the state in which the ink jet head was shifted from a position of a cap provided in the printer, and the head was not capped, the ink jet head was left still for 7 days in an environment at a temperature of 40° C. and a relative humidity of 20%. After the ink jet head was left still as described above, the moisturizing cap was filled with the maintenance liquid and then capped on the ink jet head so that the maintenance liquid was not in contact with the nozzle surface of the ink jet head, and the ink jet head was again left still for 7 days in an environment at a temperature of 40° C. and a relative humidity of 20%. Subsequently, the number of cleaning operations performed until all the nozzles normally ejected the inks was counted and then evaluated by the following evaluation criteria. Among the inks of the ink set, an ink having the worst evaluation result was used for the evaluation.

### Evaluation Criteria

A: When number of cleaning operations is less than two, all nozzles are recovered.
B: When number of cleaning operations is two to less than six, all nozzles are recovered.
C: When number of cleaning operations is six or more, all nozzles are recovered, or some nozzle is not recovered.
   2.4. Clogging Recovery Property when Maintenance Liquid being Abnormally in Contact with Ink Jet Head (Clogging Recovery Property in Abnormal Contact State)

An LX-10050MF modified machine manufactured by Seiko Epson Corporation was prepared, and the ink compositions of Examples and Comparative Examples were charged in the respective ink jet heads. In the maintenance liquid received in a container, the nozzle surface was dipped for one minute. Subsequently, after the nozzle surface was recovered from the maintenance liquid, the cleaning operation to wipe the nozzle surface was performed once with a wiper, and a nozzle inspection was then performed. Among the inks of the ink set, an ink having the worst evaluation result was used for the evaluation.

### Evaluation Criteria

A: non-ejection nozzle is observed.
B: non-ejection nozzle is not observed.

### 2.5. Evaluation of Stacking Property

In an LX-10050MF modified machine manufactured by Seiko Epson Corporation, the ink compositions of Examples and Comparative Examples were charged, and in an environment at a temperature of 10° C. and a relative humidity of 85%, a solid pattern was recorded at a duty of 100% on a recording medium (A4 size, Xerox P paper, copy paper manufactured by Fuji Xerox Co., Ltd., basis weight: 64 g/m², paper thickness: 88 μm). When the ink compositions used for the recording is a four-color set, the ink compositions each responsible for a 0.25 duty were mixed together and used. Subsequently, after 100 sheets of printed paper were stacked on a paper outlet tray of the printer, the evaluation was performed by visual inspection using the following evaluation criteria.

### Evaluation Criteria

A: media are neatly received in paper outlet tray.
B: media are not neatly received in paper outlet tray.

### 3. Evaluation Result

From the results in Tables 1 to 4, compared to Comparative Examples 1 to 10 in which the content A (percent by mass) of the moisturizing agent component with respect to the total mass of the moisturizing agent component and the water does not satisfy Equation (1), it was found that in each of Examples 1 to 16, the change in ink composition with the moisturizing time is suppressed.

In addition, Reference Examples 1 to 6 are each an example in which one water-based ink composition, that is, a cyan or a black ink composition, of the ink set A was only used as the ink. Since only one type of ink was used, Xₘᵢₙ and Xₘₐₓ were equal to each other. In both cases described above, it was found that when the content A (percent by mass) of the moisturizing agent component with respect to the total mass of the moisturizing agent component and the water satisfies Equation (1), although the change in ink composition with the moisturizing time is suppressed, since Xₘᵢₙ and Xₘₐₓ are equal to each other, a numerical range in which the content A (percent by mass) in the maintenance liquid satisfies Equation (1) is narrow as compared to that of Examples 1 to 16.

What is claimed is:

1. A water-based maintenance liquid used for a recording apparatus,
the recording apparatus being an apparatus to perform recording by ejecting at least two types of water-based ink compositions from an ink jet head,
the ink jet head having a nozzle surface in which nozzles to eject the water-based ink compositions are formed,
in the nozzle surface, the nozzles being formed respectively for the at least two types of water-based ink compositions,
the maintenance liquid being used to moisturize the nozzle surface by being supplied to a cap portion which covers the nozzle surface, the maintenance liquid comprising:
water; and
a moisturizing agent component containing at least one type of moisturizing agent,
wherein the moisturizing agent component is a water-soluble organic compound, and
a content A (percent by mass) of the moisturizing agent component with respect to a total mass of the moisturizing agent component and the water satisfies the following Equation (1):
Xₘᵢₙ−5≤A≤Xₘₐₓ+5 Equation (1)
where when the following procedures 1 to 3 are performed, Xₘᵢₙ and Xₘₐₓ are each a value defined by the following definition 1,
wherein in the procedure 1, at least three types of liquid compositions P₁, P₂, P₃, . . . Pₙ, n indicating an integer of 3 or more, which are each formed from a moisturizing agent component and water and which have contents B (percent by mass) of the moisturizing agent components each with respect to a total mass of the moisturizing agent component and the water being different from each other and the at least two types of water-based ink compositions Q₁, Q₂, . . . Qₘ, m indicating an integer of 2 or more, are prepared; and the moisturizing agent component of the liquid composition has the same composition as that of the moisturizing agent component included in the maintenance liquid,
a container α in which the liquid composition P₁ is received and a container β in which the ink Q₁ is received, the mass thereof being the same as that of the liquid composition P₁, are left still in a tightly closed container in an environment at a temperature of 25° C. and a relative humidity of 50%; and based on the change in mass of the liquid composition P₁ with time, a moisture absorption rate (g/h) of the liquid composition P₁ to the ink Q₁ is calculated,
a moisture absorption rate (g/h) of the ink Q₁ to the liquid composition P₁ is also calculated in a manner similar to that described above, and
except for that the liquid composition P₁ is changed, the above operation is performed on each of the liquid compositions P₂, P₃, . . . Pₙ under conditions similar to the above conditions; and the moisture absorption rates of the liquid compositions and n types of moisture absorption rates of the ink Q₁ corresponding thereto are calculated,
in the procedure 2, in a graph in which the vertical axis indicates the moisture absorption rate, and the horizontal axis indicates the content B of the moisturizing agent component of the liquid composition, after the moisture absorption rates (g/h) of the liquid compositions and the n types of moisture absorption rates (g/h) of the ink Q₁ corresponding thereto are plotted with the content B, an approximate straight line of the moisture absorption rates (g/h) of the liquid compositions and an approximate straight line of the n types of moisture absorption rates (g/h) of the ink Q₁ are formed, respectively, and
a content B located at a point at which the approximate straight line of the moisture absorption rates (g/h) of the liquid compositions and the approximate straight line of the n types of moisture absorption rates (g/h) of the ink Q₁ are intersected to each other is represented by X₁,
in the procedure 3, except for that the ink Q₁ is changed, the procedures 1 and 2 are performed on each of the inks Q₂ . . . Qₘ under conditions similar to the above conditions, so that X₁, X₂, . . . Xₘ are obtained, and
as the definition 1, among X₁, X₂, . . . Xₘ thus obtained, the maximum value is represented by Xₘₐₓ, and the minimum value is represented by Xₘᵢₙ.

2. The maintenance liquid according to claim 1,
wherein the content A (percent by mass) of the moisturizing agent component satisfies the following Equation (2):
Xₘᵢₙ≤A≤Xₘₐₓ Equation (2).

3. The maintenance liquid according to claim 1,
wherein the content A (percent by mass) of the moisturizing agent component satisfies the following Equation (3):
Xₘᵢₙ+[(Xₘₐₓ−Xₘᵢₙ)/4]≤A≤Xₘₐₓ−[(Xₘₐₓ−Xₘᵢₙ)/4] Equation (3).

4. The maintenance liquid according to claim 1,
wherein at least one of the at least two types of water-based ink compositions contains inorganic oxide particles.

5. The maintenance liquid according to claim 1,
wherein the moisturizing agent component contains at least one selected from the group consisting of a water-soluble organic compound which is an organic solvent having a standard boiling point of 130° C. or more and a water-soluble organic compound in the form of a solid at 25° C.

6. The maintenance liquid according to claim 1,
wherein the content A (percent by mass) of the moisturizing agent component is 10 to 40 percent by mass.

7. The maintenance liquid according to claim 1,
wherein a value (percent by mass) obtained by subtracting the Xₘᵢₙ from the Xₘₐₓ is 2.0 to 15 percent by mass.

8. The maintenance liquid according to claim 1,
wherein at least one of the at least two types of water-based ink compositions contains a colorant, and a content thereof with respect to a total mass of the water-based ink compositions is 7.0 percent by mass or more.

9. The maintenance liquid according to claim 1,
further comprising an antiseptic agent.

10. The maintenance liquid according to claim 1,
wherein at least one of the at least two types of water-based ink compositions contains a water-soluble organic compound which is an organic solvent having a standard boiling point of 130° C. or more and/or a water-soluble organic compound in the form of a solid at 25° C.

11. A maintenance method comprising:
supplying the maintenance liquid according to claim 1 to the cap portion which covers the nozzle surface of the ink jet head of the recording apparatus so as to moisturize the nozzle surface.

12. A recording apparatus comprising:
the maintenance liquid according to claim 1; and
an ink jet head in which the nozzle surface is moisturized by the maintenance liquid.

13. The recording apparatus according to claim 12,
further comprising a supply mechanism to supply the maintenance liquid,
wherein the supply mechanism includes a water supply mechanism to supply water to the maintenance liquid.

14. An ink set comprising:
the maintenance liquid and the at least two types of water-based ink compositions, which are according to claim 1.
